(19) United States
(12) Patent Application Publication
(10) Pub. No.: US 2018/0044988 A1
(43) Pub. Date: Feb. 15, 2018

(54) LIFT SYSTEMS AND DEVICES

(71) Applicant: Vivint Solar, Inc., Lehi, UT (US)

(72) Inventors: Mark S. McCall, Santa Rosa, CA (US); Kunio Hasebe, Santa Rosa, CA (US); Willard S. MacDonald, Sebastopol, CA (US)

(21) Appl. No.: 15/673,198

(22) Filed: Aug. 9, 2017

Related U.S. Application Data
(60) Provisional application No. 62/372,536, filed on Aug. 9, 2016.

(51) Int. Cl. E06C 7/12

(52) U.S. Cl. CPC E06C 7/12

(57) ABSTRACT

The present disclosure is directed to a ladder guide device. A guide device may include at least one hook configured to couple to a ladder. The guide device may also include at least one surface configured to guide an object over a discontinuity in the ladder as the object moves in a direction parallel to a longitudinal axis of the ladder.

### CROSS-REFERENCE TO RELATED APPLICATION

A claim for benefit of priority to the Aug. 9, 2016 filing date of the U.S. Patent Provisional Application No. 62/372,536, titled “LIFT SYSTEMS AND DEVICES” (the '536 Provisional Application), is hereby made pursuant to 35 U.S.C. §119(e). The entire disclosure of the '536 Provisional Application is hereby incorporated by reference.

### TECHNICAL FIELD

This disclosure relates generally to a lift systems and devices, and more specifically, to ladder lift systems and devices for lifting and/or guiding an object across at least a portion of a ladder.

### BRIEF SUMMARY

In one specific embodiment, a guide device may be configured to couple to a ladder. The guide device may also be configured to guide an object across at least a portion of a ladder. For example, the guide device may be configured to guide the object over a discontinuity in the ladder as the object moves in a direction parallel to a longitudinal axis of the ladder.

According to another embodiment, a guide device includes at least one hook configured to couple to a ladder. The guide device may also include at least one surface configured to guide an object across at least a portion of the ladder. For example, the guide device may be configured to guide the object over a discontinuity in the ladder as the object moves in a direction parallel to a longitudinal axis of the ladder.

In another embodiment, a guide device may include at least one first hook configured to secure to a rung of a ladder, and at least one second hook configured to secure to another, different rung of the ladder. The guide device may further include at least one surface coupled to the at least one first hook and the at least one second hook and configured to be spaced from each of the rung of the ladder, the another, different rung of the ladder, and one or more rails of the ladder while being secured to the ladder.

In another embodiment, a guide device may include a first member including a first hook for securing to a first rung of a ladder and a second hook for securing to a second, different rung of the ladder. The first member may further include a surface spaced from each of the first and second hooks. The guide device may also include a second member spaced from the first member and including a third hook for securing to the first rung, and a fourth hook for securing to the second, different rung. Further, the second member may include a surface spaced from each of the third and fourth hooks. In addition, the guide device may include a third member extending between the first and second members and having a major surface perpendicular to major surfaces of the first and second members.

According to yet another embodiment, a system may include a pulley system including a pulley and a rope configured to attach to an object. The pulley system may also include a ladder. In some embodiments, the pulley system may be coupled to a ladder. Moreover, the pulley system may include a guide device coupled to the ladder and configured to guide the object over a discontinuity in the ladder as the object moves in a direction parallel to a longitudinal axis of the ladder. For example, the object may include a solar module lifting hook and a solar module.

According to yet another embodiment, a pulley system may include a brake and a rope, which may couple to an object. The brake may be configured to allow the object (e.g., a solar module) to be pulled upward (e.g., up a ladder), and prevent the object from sliding downward (e.g., down the ladder) if the rope is released (e.g., by a user). The brake is configured to be disabled to allow the object and/or the rope to slide downward. According to various embodiments, the pulley system may couple to the ladder and/or include the ladder. Moreover, the system may include a guide device coupled to the ladder and configured to guide the object over a discontinuity in the ladder as the object moves in a direction parallel to a longitudinal axis of the ladder. For example, the object may include a solar module lifting hook and a solar module.

Other aspects, as well as features and advantages of various aspects, of the present disclosure will become apparent to those of skill in the art through consideration of the ensuing description, the accompanying drawings and the appended claims.

### BRIEF DESCRIPTION OF THE DRAWINGS

FIG. 1 illustrates a pulley;

FIG. 2 depicts a pulley system including a pulley coupled to a ladder;

FIGS. 3 and 4 illustrate a ladder including a plurality of sections;

FIG. 5 illustrates one embodiment of an example guide device;

FIG. 6 illustrates another embodiment of an example guide device;

FIG. 7 depicts an example guide device coupled to a ladder;

FIGS. 8-12 depict an example system including a pulley system, a ladder, and a guide device;

FIG. 13 illustrates an example guide device;

FIG. 14 illustrates an example guide device;

FIG. 15 is another illustration of an example guide device;

FIG. 16 depicts an example guide device including a catch;

FIG. 17 is an illustration of an example guide device including a catch, a ladder, and a lifting hook;

FIG. 18 depicts an example guide device coupled to a pulley;

FIGS. 19-23 depict an example pulley system;

FIGS. 24-26 depict example rung blockers; and

FIG. 27 illustrates another example pulley system.

### DETAILED DESCRIPTION

Referring in general to the accompanying drawings, various embodiments of the present disclosure are illustrated to show the structure for lift devices and lift systems. Common elements of the illustrated embodiments are designated with like numerals. It should be understood that the figures presented are not meant to be illustrative of actual views of any particular portion of the actual device structure, but are merely schematic representations which are employed to more clearly and fully depict embodiments of the disclosure.

The following provides a more detailed description of the present disclosure and various representative embodiments thereof. In this description, functions may be shown in block diagram form in order not to obscure the present disclosure in unnecessary detail. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Solar photovoltaic (PV) cells use light energy (photons) from the sun to generate electricity through a photovoltaic effect. A PV solar module includes PV cells mounted behind glass and typically includes a frame at least partially surrounding the edges of the cells and glass. A PV system, which includes one or more solar modules installed on a roof, and various other electrical components, may be used to generate and supply electricity in utility, commercial and residential applications.

The soft-costs of installing a PV system (i.e., costs excluding the cost of the modules, inverters, and other equipment) can be more than half of the entire installation cost (e.g., more than 65% of the total cost of the installation). A large portion of the soft-costs is labor costs, including the cost of injury and accidents and workman's compensation insurance.

Solar installation companies are seeking ways to reduce labor costs. One aspect of installation labor is moving solar modules (e.g., lifting and carrying solar modules to a mounting site). Moving solar modules is a demanding process and may require physically strong personnel. For example, a typical residential solar PV installation has around 18 solar modules and, typically, each solar module is approximately 0.9×1.6 meters in dimensions and approximately 42 pounds in weight. Solar modules are typically carried up a ladder and attached to a roof of a house, which is typically 5 to 8 meters tall. This can put significant strain on a person, who must simultaneously support the awkward shaped and heavy solar module during transportation, especially while ascending a ladder. Further, solar modules may have a sharp edge that is, for example, 1.5-2.5 mm thick and can cut into a hand of the person carrying the solar module. A solar module is often hefted over a person's shoulder and may contact the back of the person carrying the solar module. Accidents may occur as a consequence of fatigue or loss of balance. The Occupational Safety and Health Administration (“OSHA”) requires maintaining three points of contact when climbing a ladder. This presents a challenge when personnel must climb a ladder while carrying a module.

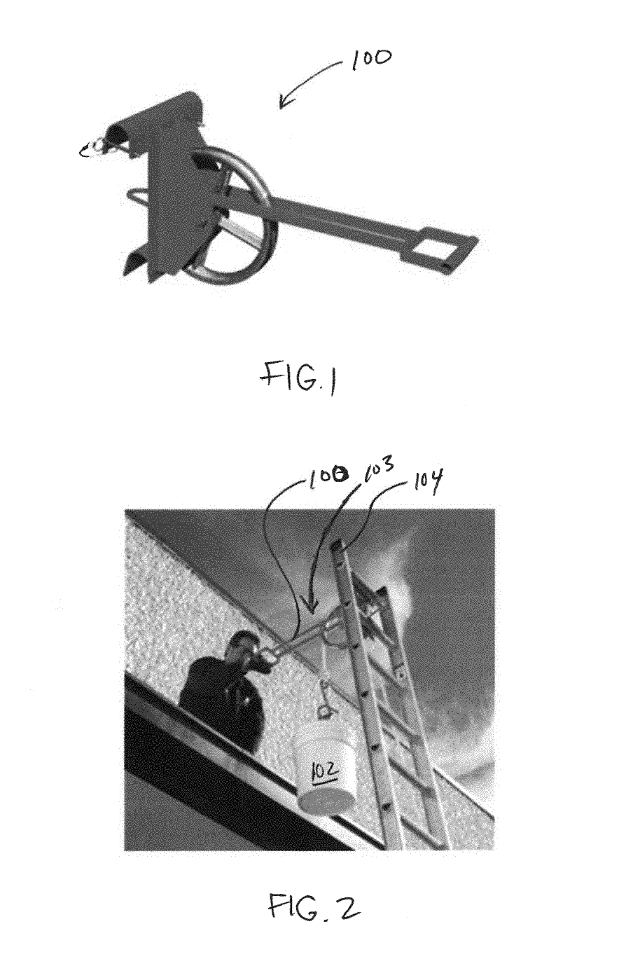

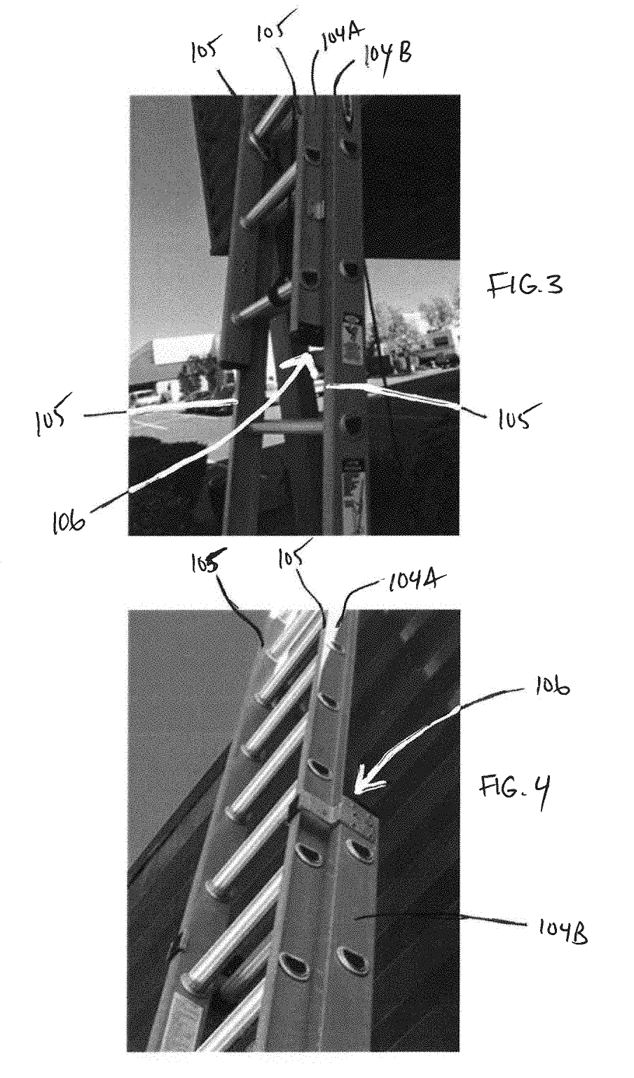

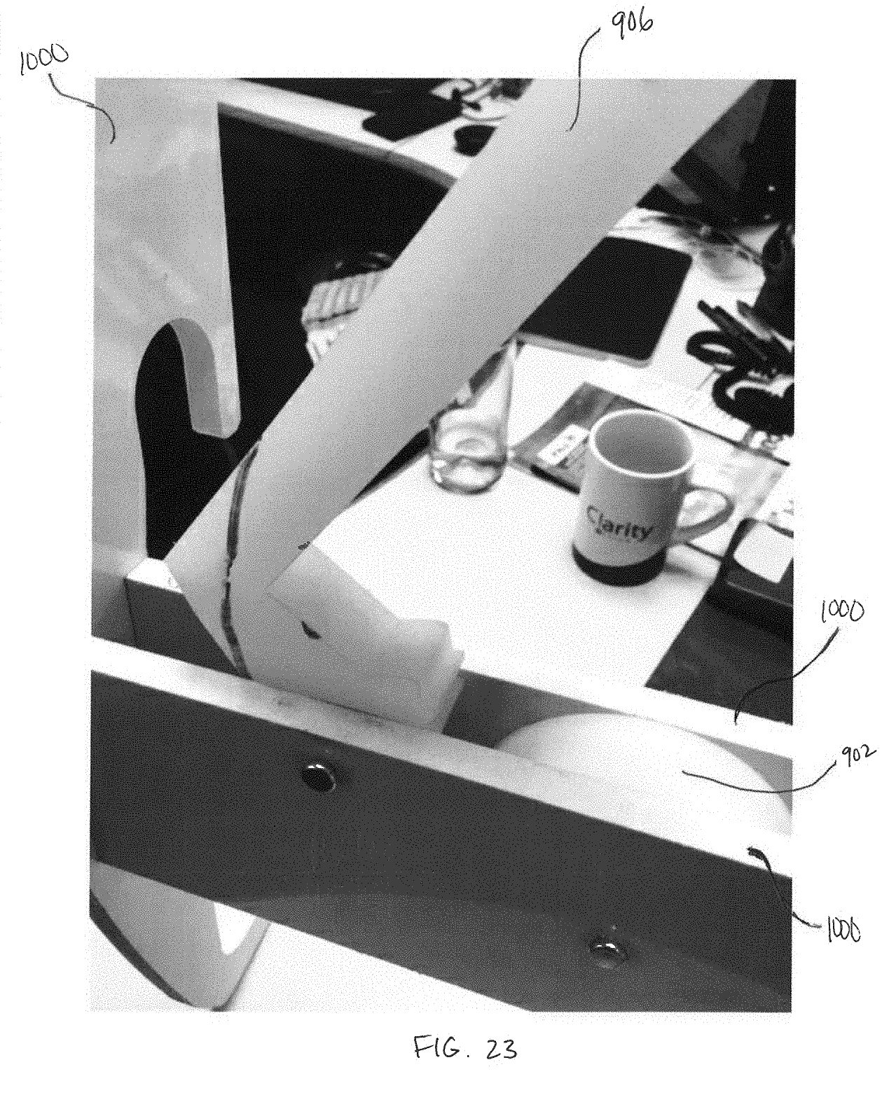

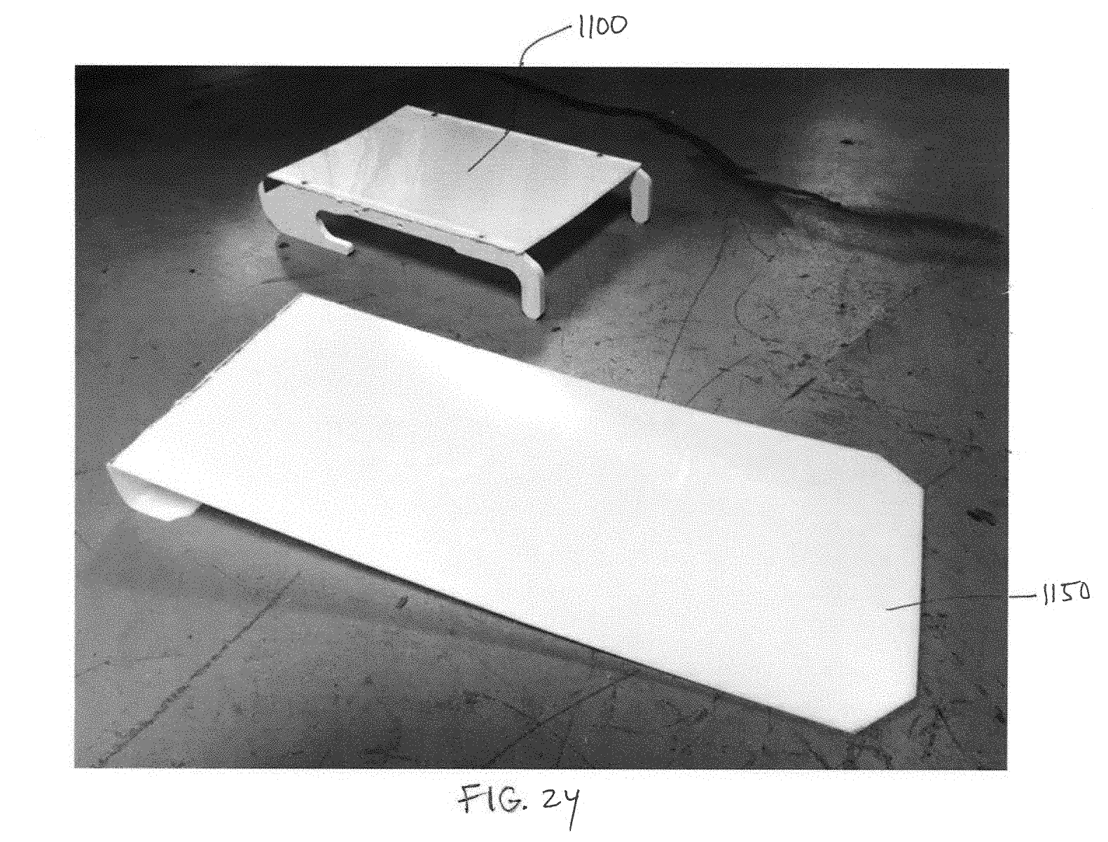

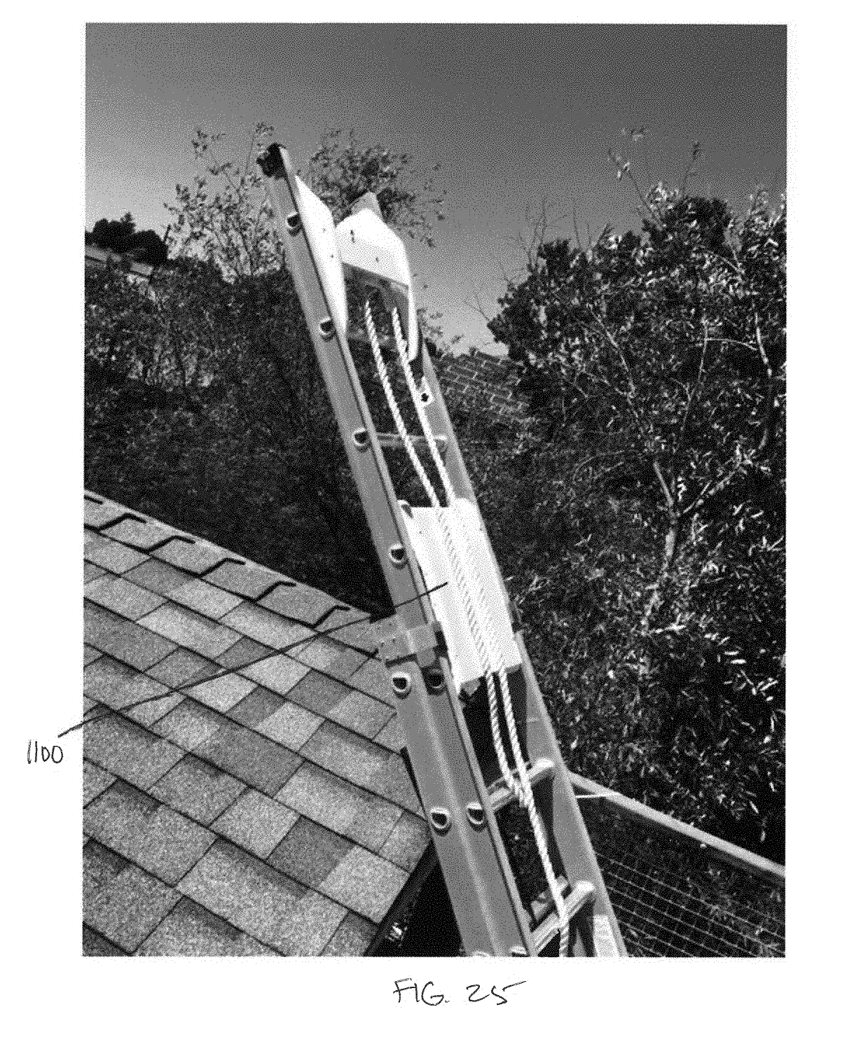

As will be appreciated, a pulley system may include one or more pulleys and a rope (e.g., a single continuous rope) to transmit a tension force around the one or more pulleys to lift or move a load. FIG. 1 depicts a pulley 100 that is mounted with its axis of rotation parallel to the ladder. As described more fully below with reference to FIGS. 19-23, some embodiments may include a pulley that is mounted with its axis of rotation substantially perpendicular to a longitudinal axis of a ladder. FIG. 2 illustrates a pulley system 103, which is coupled to a ladder 104 and may be configured to move an object (e.g., bucket 102) adjacent ladder 104 and toward pulley 100. More specifically, the object may be positioned near a surface of ladder 104 (e.g., near a surface of one or more rails of ladder 104) while being moved.

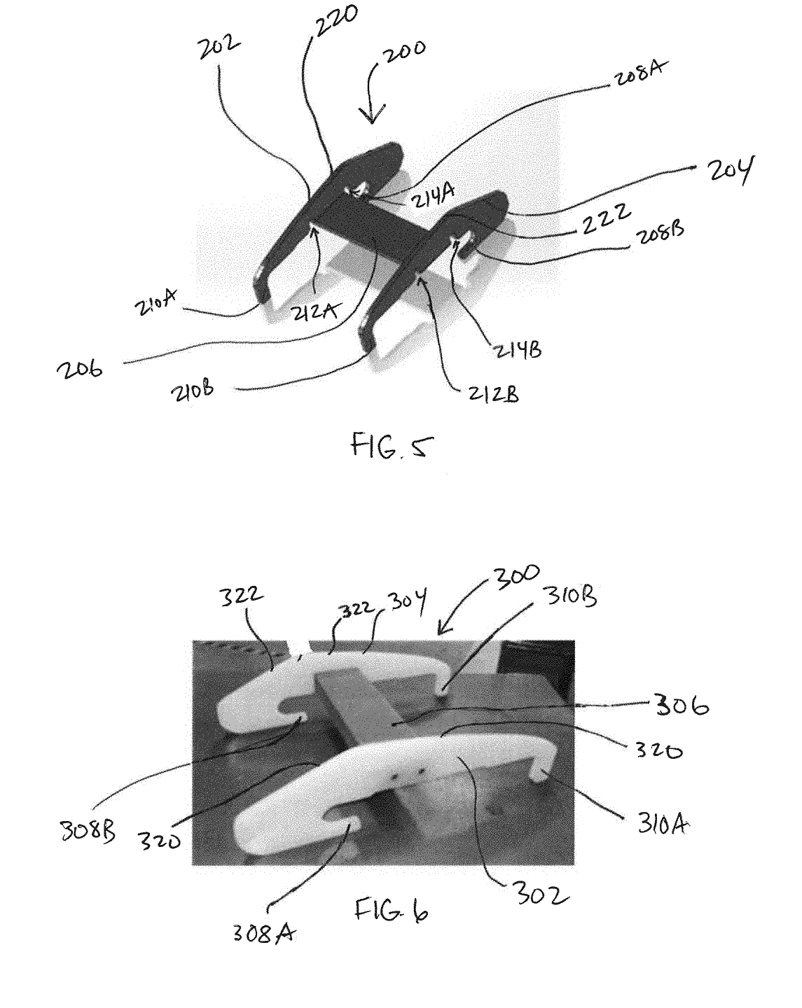

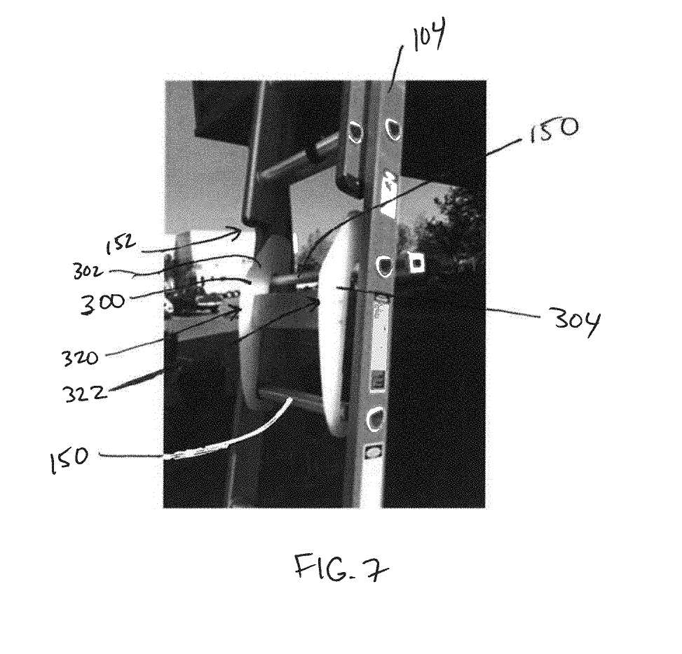

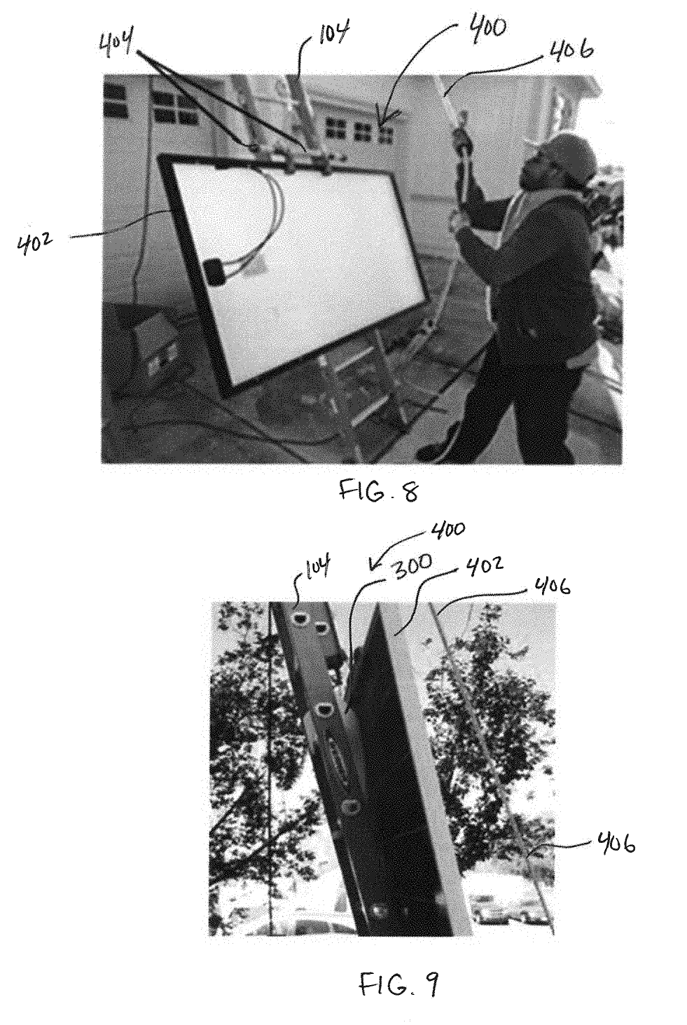

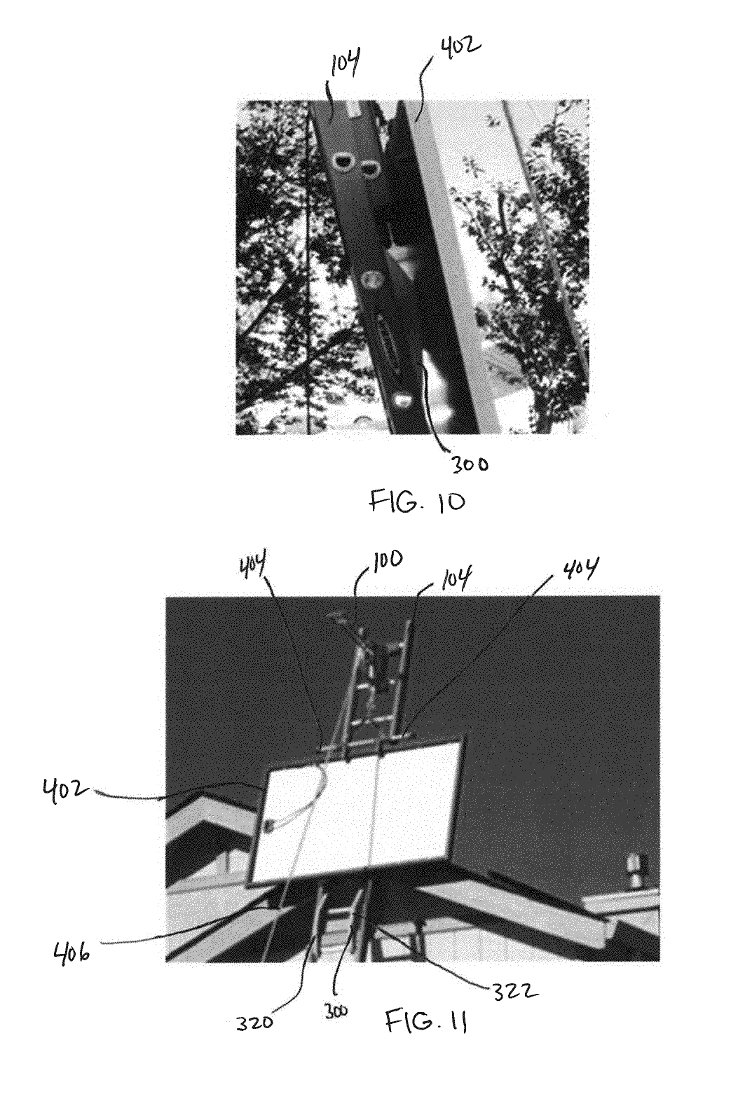

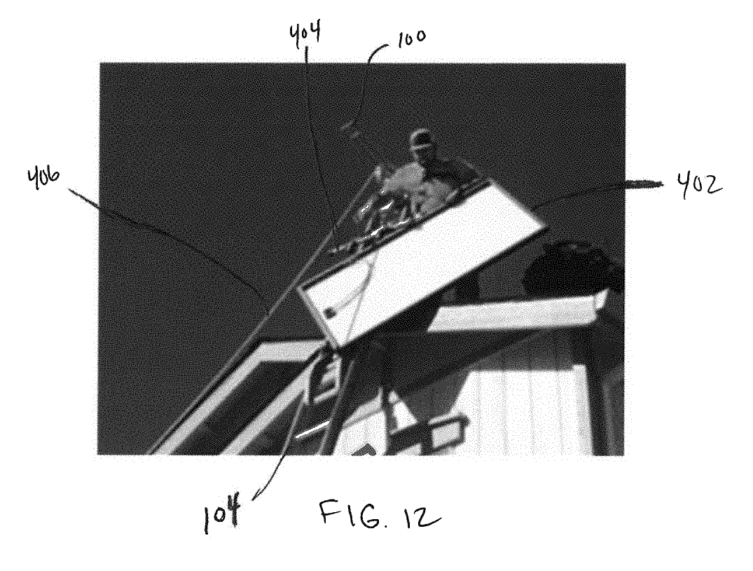

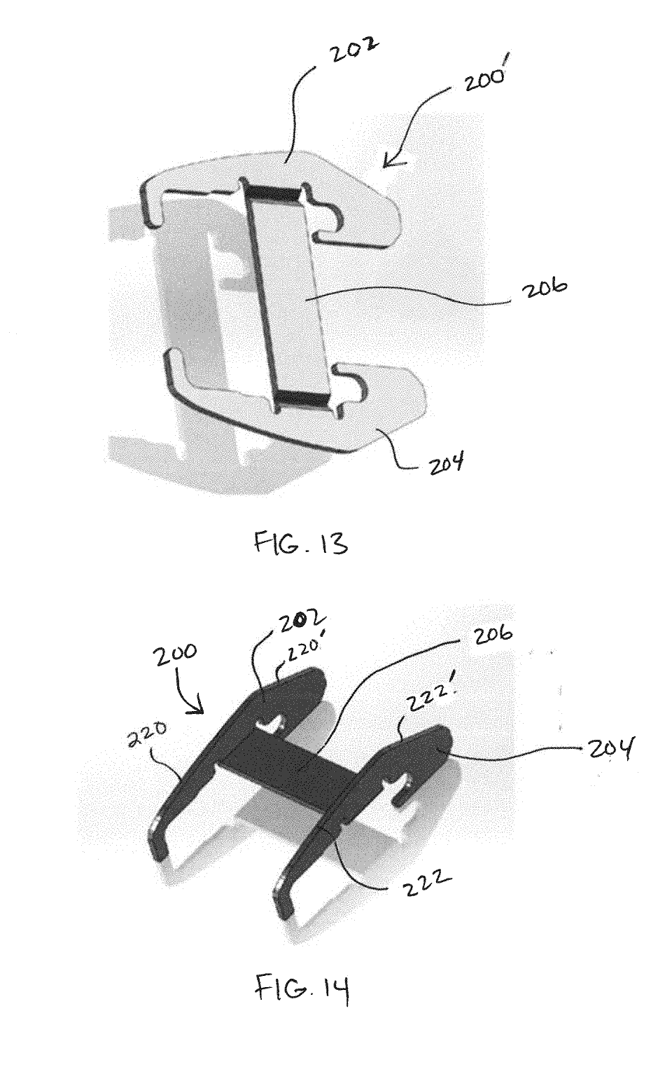

As will be appreciated, and as illustrated in FIGS. 3 and 4, a ladder (e.g., ladder 104) may include a plurality of sections (e.g., sections 104A and 104B). These sections cause an offset (e.g., lateral offset) between sections, and thus, discontinuities 106 in a surface 105 of rails of the ladder may exist. As an object (e.g., a solar module) is moved across at least a portion of the ladder, the object may undesirably catch or bang against the ladder (e.g., at, or proximate, discontinuities 106).

Various embodiments disclosed herein relate to a novel ladder guide device. A guide device may provide a ramp to guide an object (e.g., a solar module) across steps or discontinuities in a ladder. For example, a guide device may provide a ramp to guide an object (e.g., a solar module) across a step from one or more rails of one ladder section to one or more rails of another ladder section. Further, a guide device may guide an object across a hook of a ladder (e.g., at a top of a ladder section), or across a strap (e.g. Velcro safety straps) that may be used to secure the ladder to a roof or an eave. As a result, a guide device, in accordance with various embodiments disclosed herein, may decrease the likelihood of, or possibly prevent, an object from banging against the ladder or getting caught while being moved along the ladder.

FIG. 5 illustrates an example guide device 200 including a member 202 and a member 204 spaced from member 202. Device 200 further includes a member 206 positioned between members 202 and 204. Member 202 includes a surface 220 and member 204 includes a surface 222. In one embodiment, each of surface 220 and surface 222 include a ramp shape.

Device 200 further includes hooks 208 and 210. More specifically, device 200 includes rung hooks 208A/208B and rung hooks 210A/210B. For example only, rung hooks 208A/208B may also be referred to herein as “upper rung hooks” and rung hooks 210A/210B may also be referred to herein as “lower rung hooks.” According to one embodiment, device 200 may also include grooves 212A/212B and grooves 214A/214B.

Device 200 is configured to couple to a ladder and provide a substantially continuously smooth surface along a surface of a ladder. More specifically, device 200 is configured to attach to one or more rungs of a ladder and provide a smooth transition as an object (e.g., a solar module) is moved along the rails of the ladder (e.g., via a pulley). Stated another way, while device 200 is coupled to a ladder, surfaces 220 and 222 may guide an object over a discontinuity in the ladder. As will be appreciated, device 200 may decrease the likelihood of, or possibly prevent, an object from banging against or getting caught in the ladder while being moved along at least a portion of the ladder (e.g., from the ground to a roof top). It is noted that it is not required that device 200 couple to one or more rungs of a ladder, rather device 300 may couple to any suitable portion of a ladder.

FIG. 6 depicts another example guide device 300. Guide device 300 includes a member 302 and a member 304 spaced from member 302. Device 300 further includes a member 306 positioned between members 302 and 304. Device 300 further includes hooks 308 and 310. More specifically, device 300 includes rung hooks 308A/308B and rung hooks 310A/310B. Rung hooks 308A/308B may also be referred to herein as “upper rung hooks” and rung hooks 310A/310B may also be referred to herein as “lower rung hooks.”

FIG. 7 depicts device 300 coupled to ladder 104. As shown in FIG. 7, device 300 may couple to rungs 150 of ladder 104. More specifically, upper rung hooks 308A/308B may couple to a first rung and lower rung hooks 310A/310B may couple to a second (e.g., lower) rung. Further, device 300 may be positioned near an end (e.g., lower end) of a section 152 of ladder 104. As will be appreciated in light of the present disclosure, a surface 320 of member 302 and a surface 322 of member 304 may be configured to guide an object over a discontinuity in ladder 104 (e.g., as the object moves in a direction parallel to a longitudinal surface of one or more rails of the ladder). Stated another way, members 302 and 304, and more specifically, surfaces 320 and 322, may guide an object over a discontinuity in ladder 104 as the object moves proximate ladder 104.

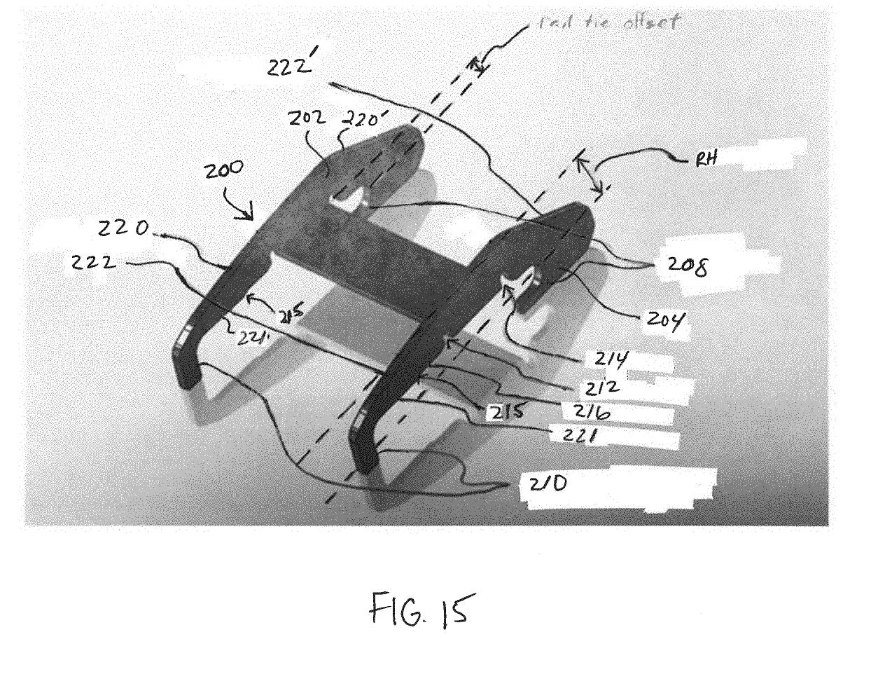

FIGS. 8-12 illustrate a system 400 including ladder 104, a lifting hook 404, a rope 406, and a pulley (not shown in FIGS. 8-10; see e.g., pulley 100 of FIG. 1, 11, or 12). In one embodiment, lifting hook 404 may couple to a solar module 402. Further, rope 406, which may be attached to lifting hook 404 and may loop through the pulley (e.g., positioned near an end of ladder 104), may be used to pull solar module 402 along (e.g., in a direction (e.g., upward) parallel to a longitudinal axis of ladder 104) and adjacent ladder 104.

A guide device, in accordance with various embodiments, may be fabricated with one or more suitable materials, including metal, wood, plastic, fiberglass, etc. The material may be a variety of thicknesses. A guide device may be manufactured as one piece or as multiple pieces connected together via welding, gluing, fastening, etc. In one embodiment, a guide device may be constructed in a plurality of members that are attached. For example, the plurality of members may be screwed, glued, and/or welded together.

In another embodiment, a guide device (e.g., guide device 200 or guide device 300) may be constructed via cutting (e.g. by milling or water jet) a single piece of material, such as polypropylene (e.g., a piece of polypropylene having a thickness of, for example, one-half inch). A single piece of material (e.g., polypropylene) may be cut with “hinges” that enable ends of the piece of material to be folded (e.g., substantially 90 degrees) to form hooks. A seam may then be welded using, for example, a polypropylene welding technique or glue.

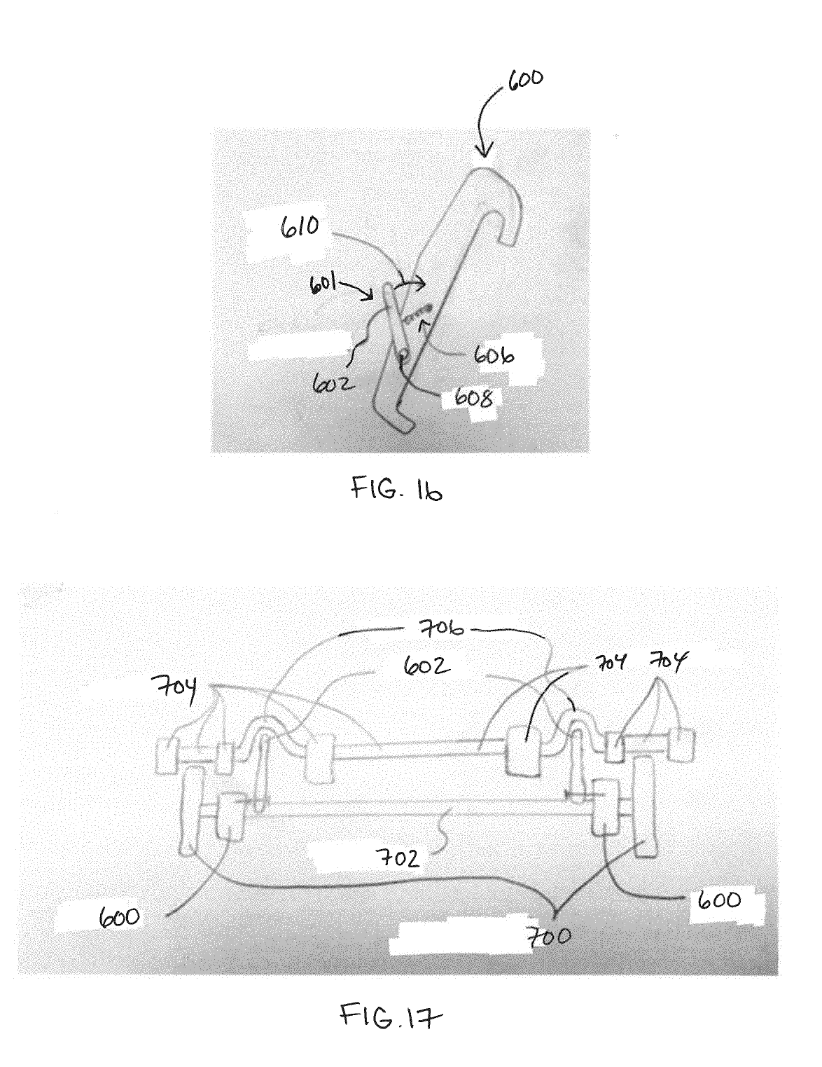

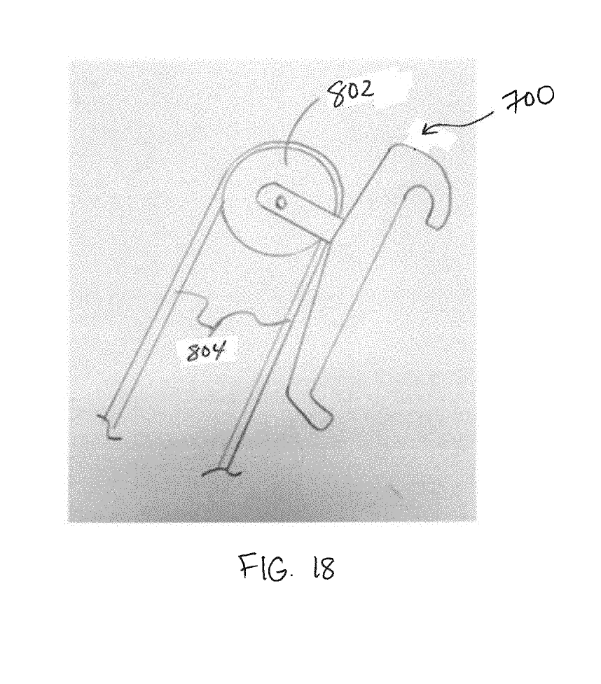

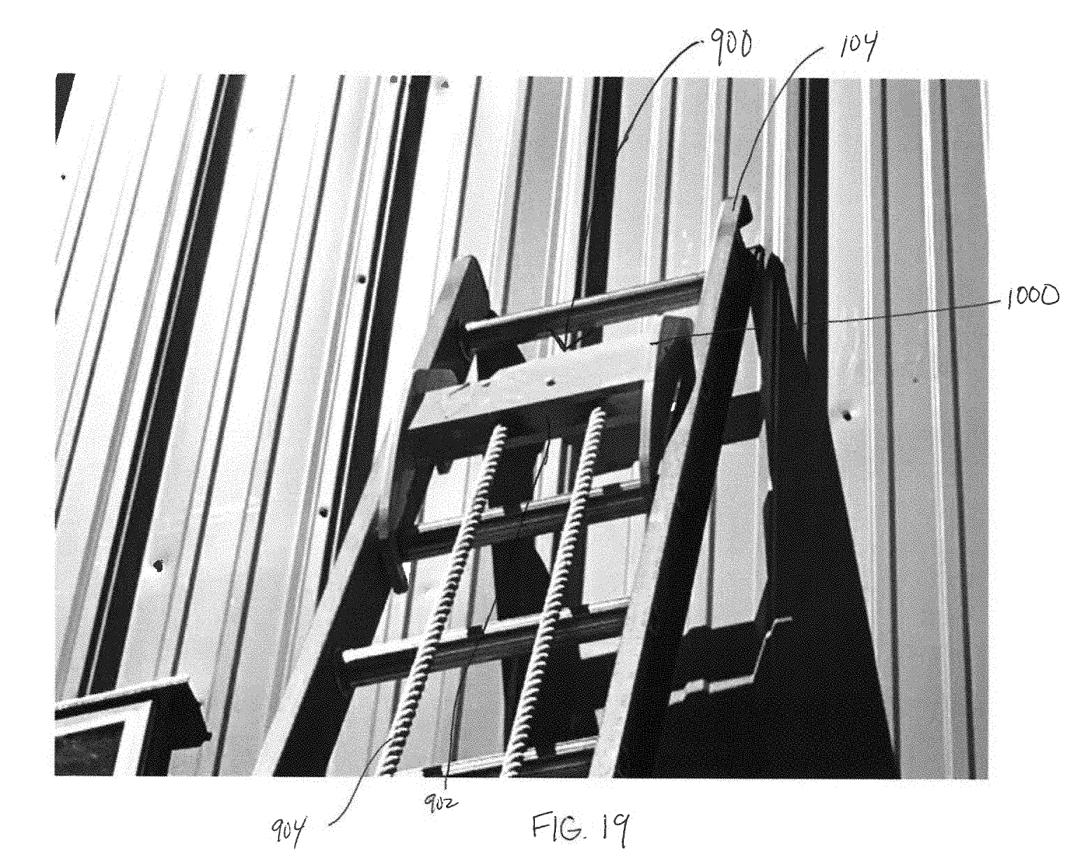

For example, with reference to FIG. 13, a guide device 200′ includes members 202, 204, and 206, wherein a major surface of members 202 and 204 is parallel to a major surface of member 206. FIG. 14 depicts guide device 200 after members 202 and 204 have been folded (i.e., substantially 90 degrees), and the major surface of members 202 and 204 is perpendicular to the major surface of member 206.

FIG. 15 illustrates various aspects of guide device 200. During a contemplated use of device 200, device 200 may be positioned between the rails of a ladder and hooked onto a ladder rung via upper rung hooks 208. Further, lower rung hooks 210 may engage another rung of the ladder (e.g., the next lower rung of the ladder), contacting the ladder rung on edges of hooks 210. Lower rung hooks 210 may prevent device 200 from sliding (e.g., upward) when an object (e.g., a solar module) is moved along (e.g., up) the rails of the ladder and smoothly transitions to sliding up the “leading edges” (e.g., surfaces 220 and 222) of device 200.

In one embodiment, a width of device 200 may be slightly less than the inside dimension of the ladder's smallest rail width, thus capturing the guide laterally. For example, the width of device 200 may be approximately 12.75 inches. A shallow slope of leading edges 220 and 222 is configured to elevate an object (e.g., a solar module) with minimal force. Device 200 may comprise a rise height RH of, for example, approximately 2.375 inches from an outside rail surface to a “crown” of guide device 200. Rise height RH may be sufficient to clear a step from one ladder segment to the next. In another embodiment, rise height RH relative to the outside surface of the rungs may be approximately 3.25 inches.

Ladder lock hardware may be part of a ladder and is typically used to lock a position of one ladder section relative to another and enable a user to raise a ladder section relative to another as shown at the top of FIG. 3. With reference again to FIG. 15, in some embodiments, a device may include a step 215 from a surface 221 to a surface 216 that may provide additional clearance (e.g., to clear ladder lock hardware in the event guide device 200 is positioned over the ladder lock). In some embodiments, rail tie offset may be sufficient to avoid any ladder lock hardware.

Grooves 214 and 212, which may also be referred to as “bend reliefs,” may exist if device 200 is manufactured as a single piece and subsequently folded and welded. Surfaces 220′ and 222′ (also referred to herein as “trailing edges”) may enable an unloaded handle to slide back down the ladder without obstruction from device 200. Because the center of gravity (“CG”) of a typical solar module is located, for example, about 17 inches lower than a top edge of the solar module, as the module traverses upward, a top edge of the solar module may be elevated progressively higher than the “rise height”, until the CG reaches the “crown” of device 200, after which the solar module may pivot, and the leading top edge of the solar module may re-contact the rails of the ladder.

In various embodiments, device 200 may be attached (e.g., semi-permanently) to a ladder, or may be part of a ladder. For example, device 200 may be riveted to a side of a ladder and/or inserted into a hole through a rung of the ladder, and/or manufactured as part of the ladder (e.g., part of one or more rails of the ladder).

With reference to FIG. 16, in various embodiments, a guide device 600 may include a catch 601, which, in one embodiment, includes an arm 602, a spring 606 and a hinge 608. Catch 601 may be configured to catch (i.e., stop) an object (e.g., a solar module), thus preventing the object from crossing the arm in at least one direction. As the module is pulled up over guide device 600, arm 602 may fold down in the direction indicated by arrow 610. After a module passes by an end of arm 602, spring 606 may cause arm 602 to return to its default position, as shown in FIG. 16. If the module moves backward (e.g., slips backward) toward arm 602, the module may be stopped by arm 602. Stated another way, for example, as an object (e.g., a solar module) is pulled up a ladder, the object may pass un-obstructed over arm 602. Further, if the object, for some reason, is lowered (e.g., if a user accidentally drops the rope and the object slips), the object may be stopped by arm 602 of catch 601.

After a module is removed at an end (e.g., a top) of the ladder, a lifting hook (i.e., that captures the module for lifting) may be lowered back down toward an opposite end of the ladder. In various embodiments, a cross member of the lifting hook may be configured to avoid or disable catch 601 so that the lifting hook may descend without getting hung up on catch 601. FIG. 17, depicts a ladder including rails 700 and ladder rung 702. Further, FIG. 17 depicts device 600 including arms 602. A lifting hook 704 may include one or more grooves 706, which may also be referred to herein as a “catch avoidance.” As will be appreciated, one or more grooves 706 may enable lifting hook 704 to avoid arms 602, thus, allowing lifting hook 704 to descend without being stopped by catch 601 (see FIG. 16).

In another embodiment, a guide device may include a pulley configured to support a rope for lifting an object (e.g., a module lifting hook and a module). FIG. 18 depicts a guide device 700 including a pulley 802 and a rope 804. In this embodiment, device 700, including the pulley may be installed on an end (e.g., the top) of a ladder. In other embodiments, a guide device without a pulley (e.g., guide device 200, guide device 300, or guide device 600) may be installed at other locations along the ladder, typically lower than a device that includes the pulley (e.g., guide device 700). It is noted that the axis of rotation of the pulley may be substantially perpendicular to or parallel to a longitudinal axis of a ladder, or may have another orientation relative to the ladder.

In another embodiment, a pulley system, which may be part of or coupled to a guide device, may include a brake integrated with a pulley. The brake may be configured to allow a rope to rotate about the pulley while an object is moving in one direction (e.g., being raised), but not while the object is moving in an opposite direction (e.g., being lowered) (e.g., if a user releases the rope by accident).

The brake may be configured to be disabled by a user (e.g., at the top of a ladder) to allow an object or the rope to, for example, slide down the ladder. For example, the brake may be an arm with teeth configured to catch the rope when it passes in one direction but not in the other. Further, the brake may include an arm that rotates about a pin. The axis of rotation of the arm relative to the CG may be such that the brake may engage automatically by gravity when a user is not holding it in a disengaged position.

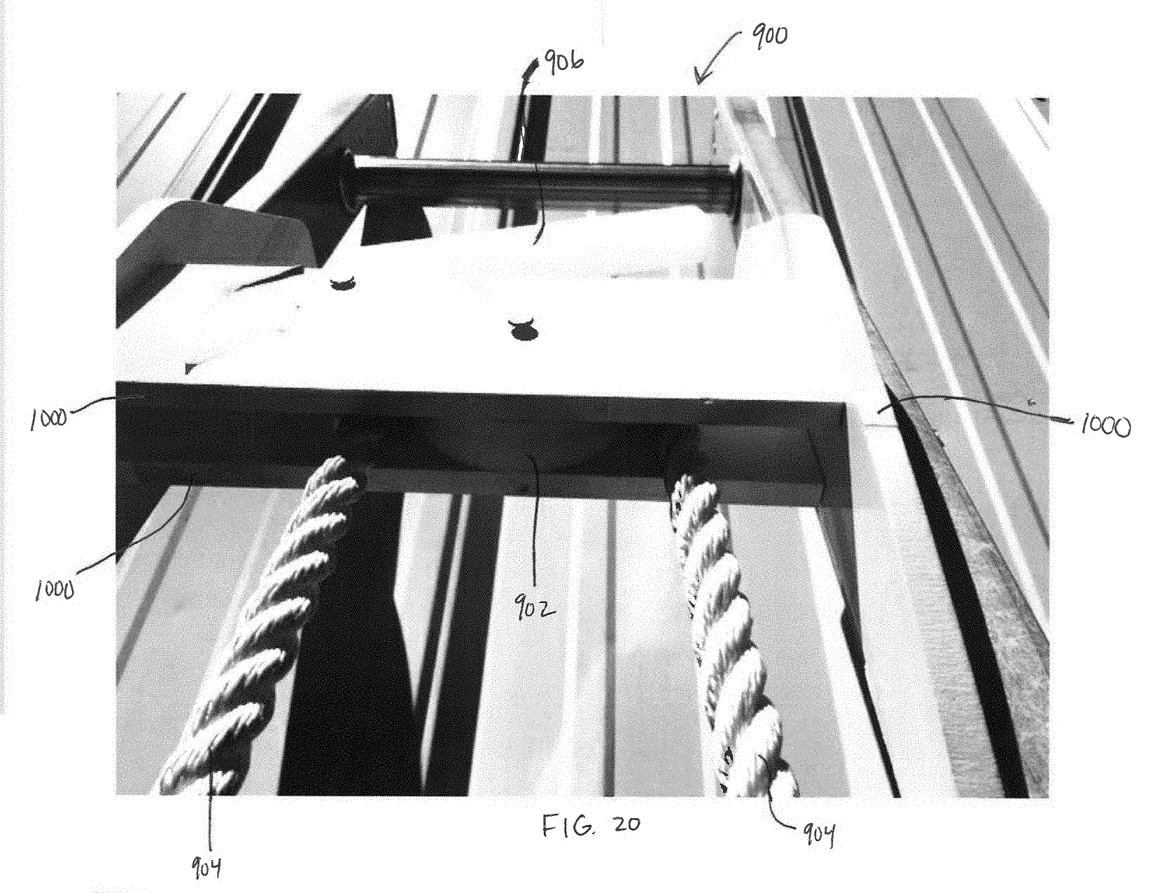

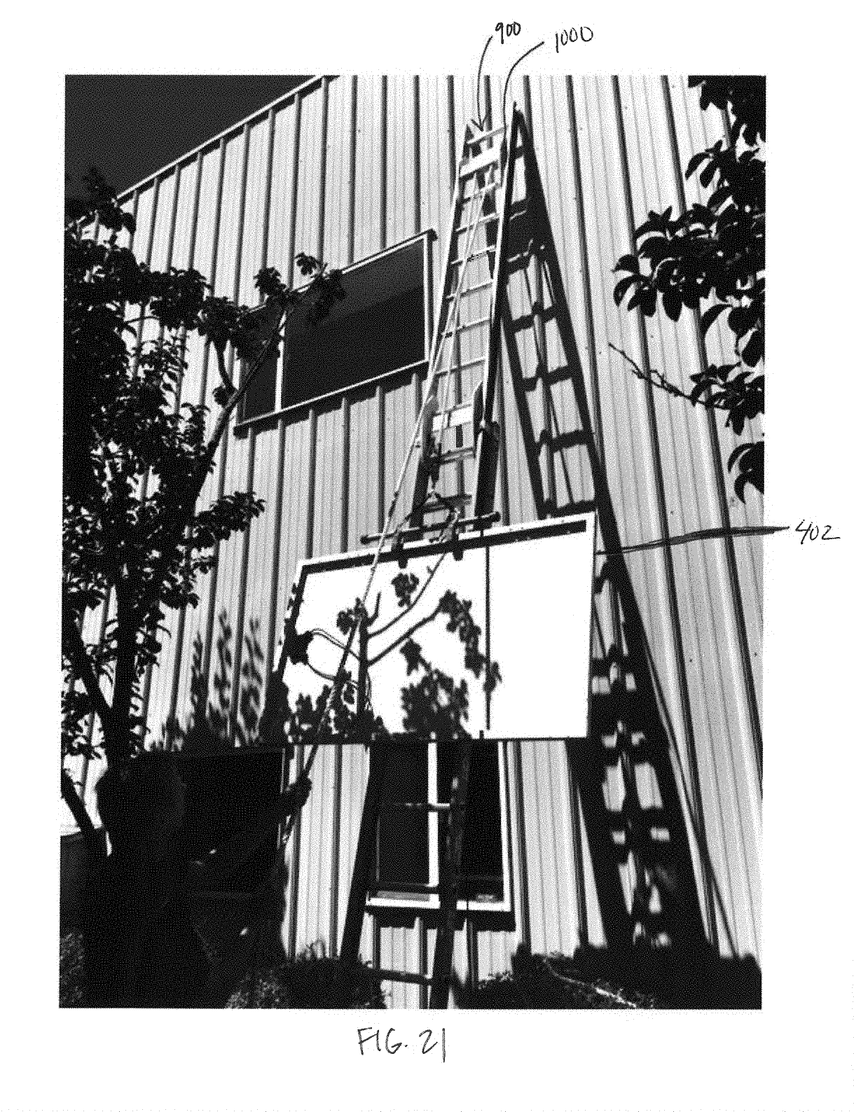

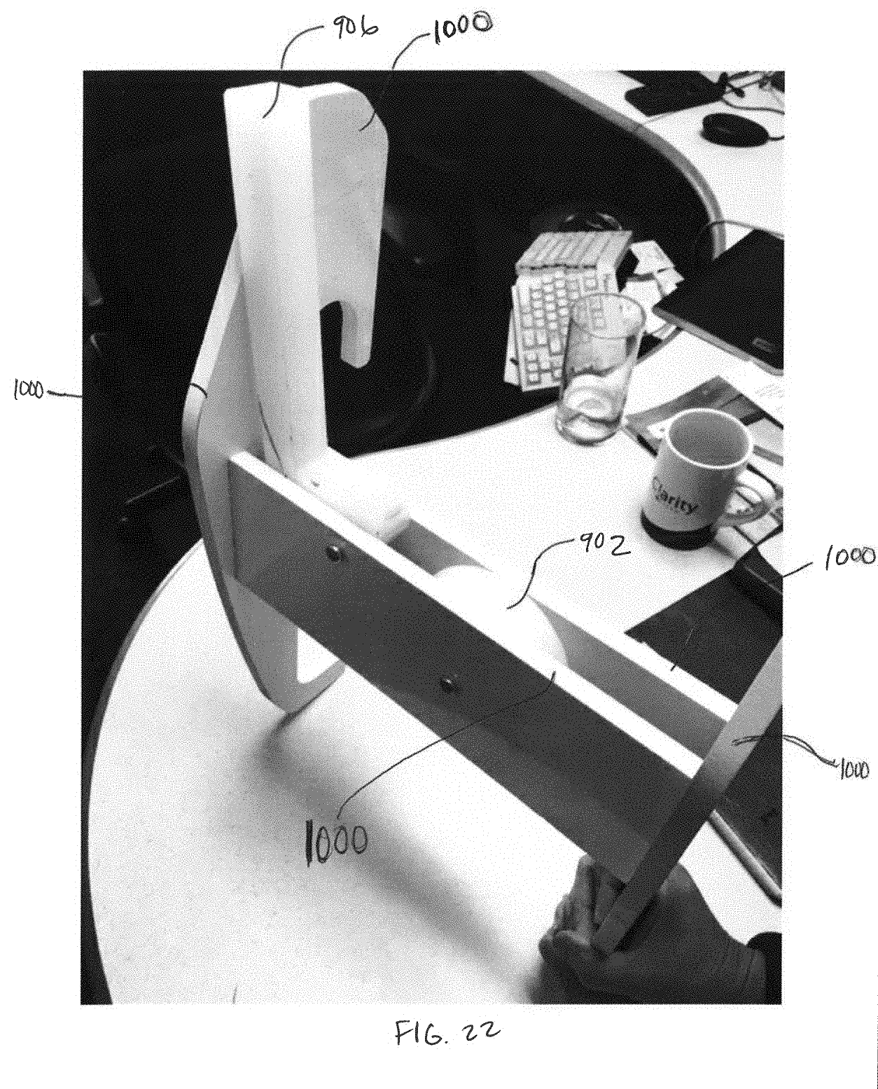

FIGS. 19-23 depict a pulley system 900, according to various embodiments. As illustrated, pulley system 900 may include a pulley 902 and a rope 904. According to some embodiments, pulley system 900 may be coupled to, or may be part of, a guide device 1000. In some embodiments, pulley 902 may be positioned between and coupled to two portions of guide device 1000 (see e.g., FIGS. 20, 22, and 23). Pulley system 900 further includes a brake 906.

In some embodiments, a guide device (e.g., guide device 200, guide device 300, guide device 600, or guide device 1000) may be configured to enable a user to ascend and/or descend a ladder while the guide device is attached to the ladder. More specifically, the guide device may be configured to provide for at least minimal openings adjacent ladder rungs for the user's hands and feet.

As will be understood, stepping on a rung of ladder positioned above a roof edge may be a hazard if, for example, the base of the ladder slides outward due to the cantilever created by the portion of the ladder extending past the roof edge and the fulcrum point where the ladder contacts the roof edge. As a result, OSHA requires that a user refrain from stepping on a rung of a ladder that is positioned above a roof edge. This may sometimes be prevented by not extending the ladder more than three rungs above the roof edge. However, in some cases, it may be desirable to extend the ladder more than 3 rungs above the roof edge so that an object (e.g. module) may be raised (e.g., by a pulley system) at least above the roof edge.

FIG. 27 depicts yet another example pulley system 1200, in accordance with at least one embodiment of the present disclosure. As illustrated, pulley system 1200 may include a pulley 1202. In some embodiments, pulley 1202 may be coupled to guide device 1300. Pulley system 1200 further includes a brake 1206, which may also be referred to as a “rope clamp.” In addition to a rope (not shown in FIG. 27), pulley system 1200 may also include an attachment device 1210, which may be configured to couple to one or more objects (e.g., one or more solar panels).

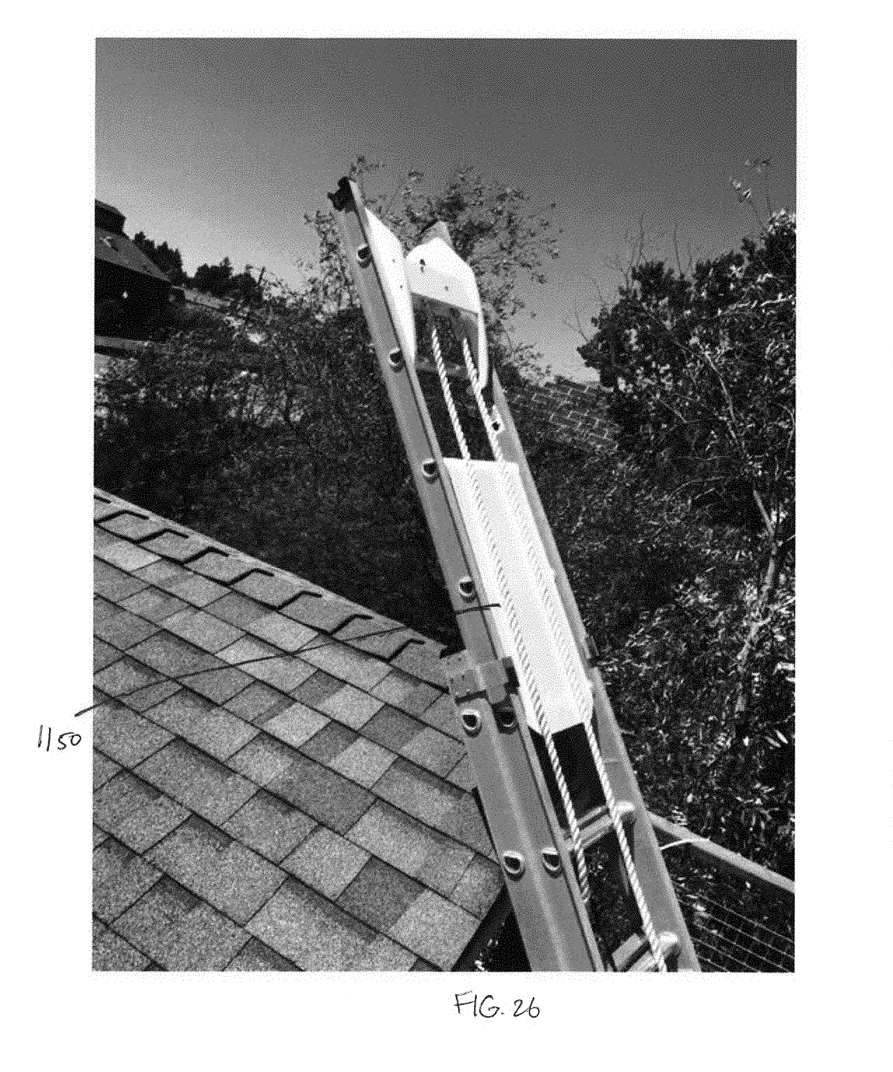

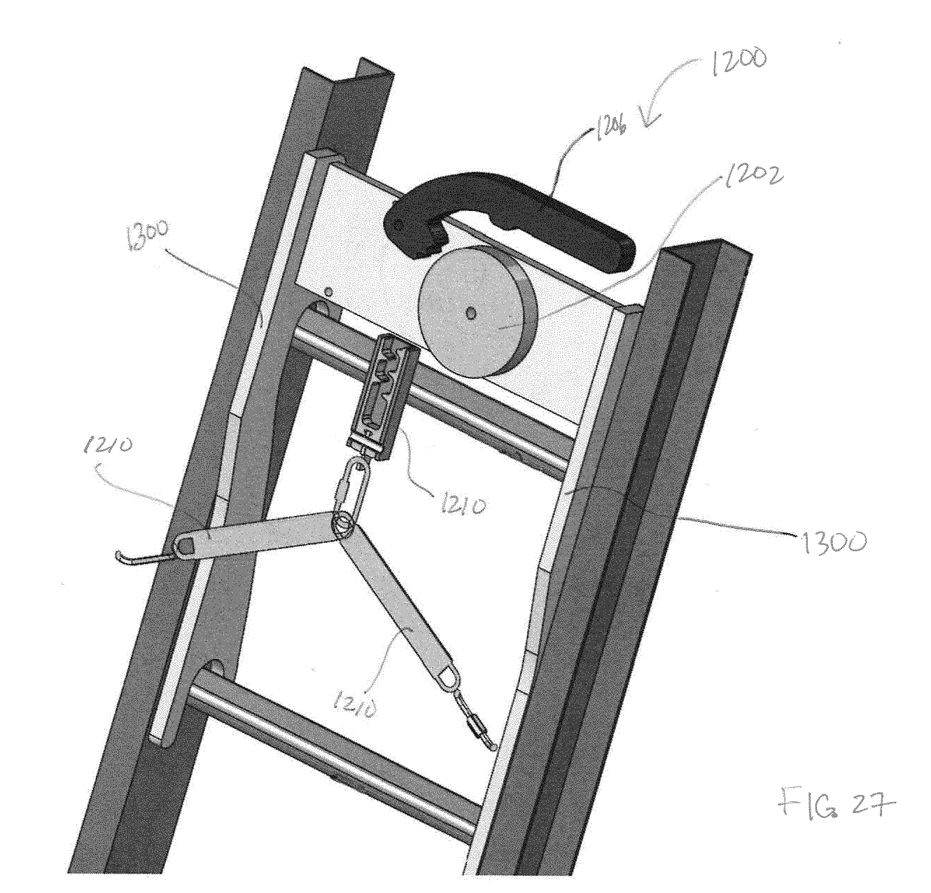

With reference to FIGS. 24-26, example rung blockers 1100 and 1150 are illustrated. A rung blocker (e.g., rung blocker 1100 or rung blocker 1150), which may be configured to prevent use of one or more ladder rungs, may be part of or coupled to a guide device or pulley system.

As noted herein, a guide device and/or pulley system may be configured to be coupled to a ladder. Further, in some embodiments, a guide device and/or pulley system may alternatively be configured to be coupled to other devices, including on-roof or off-roof scaffolding, or a roof, a gutter, and/or structure itself.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed:

1. A device, comprising:
at least one first hook configured to secure to a rung of a ladder;
at least one second hook configured to secure to another, different rung of the ladder; and
at least one surface coupled to the at least one first hook and the at least one second hook and configured to be spaced from each of the rung of the ladder, the another, different rung of the ladder, and one or more rails of the ladder while being secured to the ladder.

2. The device of claim 1, wherein the at least one first hook comprises two laterally spaced hooks configured to secure to the rung of the ladder.

3. The device of claim 1, wherein the at least one second hook comprises two laterally spaced hooks configured to secure to the another, different rung of the ladder.

4. The device of claim 1, wherein the at least one surface comprises a ramp shape configured to extend from a first section of the ladder toward a second section of the ladder offset from the first section while being secured to the ladder.

5. The device of claim 1, further comprising a catch including at least one arm configured to prevent an object from crossing the at least one arm in at least one direction.

6. The device of claim 1, wherein the at least one surface is configured to contact an object as the object moves from one section of the ladder to another, offset section of the ladder.

7. The device of claim 1, wherein the at least one surface is configured to guide an object over a discontinuity in the ladder as the object moves proximate the discontinuity in the ladder.

8. A device, comprising:
a first member including a first hook for securing to a first rung of a ladder and a second hook for securing to a second, different rung of the ladder, the first member further including a surface spaced from each of the first and second hooks;
a second member spaced from the first member and including a third hook for securing to the first rung, and a fourth hook for securing to the second, different rung, the second member further including a surface space from each of the third and fourth hooks; and
a third member extending between the first and second members and having a major surface perpendicular to major surfaces of the first and second members.

9. The device of claim 8, each of the first member, second member, and third member comprising a unitary piece of material.

10. The device of claim 9, the material comprising polypropylene.

11. The device of claim 8, each of the first member, second member, and third member comprising at least one of metal, wood, plastic, and fiberglass.

12. The device of claim 8, further including a pulley coupled to the third member.

13. The device of claim 8, wherein each of the surface of the first member and the surface of the second member comprises a ramp shape configured to extend from a first section of the ladder toward a second section of the ladder offset from the first section.

14. The device of claim 8, further comprising a catch including at least one arm and at least one spring and coupled to the at least one of the first member, the second member, and the third member.

15. A system, comprising:
a pulley system including a pulley and a rope configured to attach to an object;
a ladder; and
a guide device coupled to the ladder and configured to guide the object over a discontinuity in the ladder as the object moves in a direction parallel to a longitudinal axis of the ladder.

16. The system of claim 15, wherein the ladder includes a first section including a plurality of rails and a second section including a plurality of rails, wherein the plurality of rails of the first section are offset from the plurality of rails of the second section.

17. The system of claim 16, wherein the guide device is coupled to the first section and proximate an end of the plurality of rails of the second section.

18. The system of claim 15, wherein the pulley is coupled to the guide device.

19. The system of claim 15, wherein the object comprises:
a solar module lifting hook removably attached to the rope; and
a solar module removably coupled to the solar module lifting hook.

20. The system of claim 15, wherein the guide device comprises a ramp-shaped surface configured to guide the object over the discontinuity in the ladder.
